(19) United States
(12) Patent Application Publication
(10) Pub. No.: US 2022/0387948 A1
(43) Pub. Date: Dec. 8, 2022

(54) ULTRA FINE BUBBLE PRODUCTION APPARATUS

(71) Applicant: DAICEL CORPORATION, Osaka (JP)

(72) Inventors: Kazuhiro TERAI, Tokyo (JP); Yuko SAKAGUCHI, Tokyo (JP); Toru KITAGUCHI, Tokyo (JP); Katsuya MIKI, Tokyo (JP)

(21) Appl. No.: 17/755,621

(22) PCT Filed: Nov. 4, 2020
(86) PCT No.: PCT/JP2020/041191

§ 371 Date: May 3, 2022

(30) Foreign Application Priority Data
Nov. 5, 2019 (JP) 2019-200671

(51) Int. Cl. B01F 23/2373; B01F 23/237

(52) U.S. Cl. CPC B01F 23/2373; B01F 23/237611; B01F 2101/305

(57) ABSTRACT

This application relates to an ultra fine bubble production apparatus for producing ultra fine bubbles. The apparatus may include a container portion including a liquid and a gas, and a drive portion for pressurization in the container portion. In the pressurization, the time required for the pressure to reach the maximum pressure from the start of the pressurization can be 2.0 milliseconds or less, and the maximum pressure can be 4.00 MPa or more.

### TECHNICAL FIELD

The present disclosure relates to an ultra fine bubble production apparatus.

### BACKGROUND ART

In recent years, the applied technology of fine bubbles has attracted attention. The technology has been put into practical use in cleaning, fishing, and agriculture since around 2004, and its fields have become diverse, including food and medical care. Under such circumstances, the Ministry of Economy, Trade and Industry determined to support and promote international standardization activities related to fine bubbles in 2012 in response to demand from the industry. The Technical Committee on Fine Bubble Technologies has been established by the International Organization for Standardization (ISO) in 2013, and has discussed various definitions and standards related to “fine bubbles”. As one of their outcomes, in the related art, bubbles were not clearly distinguished by their size, however, it is now unified with the progress of academic research and technology that bubbles with a diameter of less than 100 μm are classified as fine bubbles to distinguish them from other bubbles, and bubbles with a diameter of less than 1 μm are referred to as ultra fine bubbles. (Non-patent Document 1 and Non-patent Document 2)

Various methods for producing ultra fine bubbles have been developed so far (Non-patent Document 3). Examples of these methods include a swirling liquid flow method, an ejector method, and a venturi method to generate ultra fine bubbles from large bubbles by shear force. Other examples include a pressure-dissolving method and an ultrasonic vibration method to cause a gas already dissolved in a liquid to be precipitated as ultra fine bubbles by pressure or ultrasonic waves. Another example is a mixed vapor direct contact flocculation method to mix a gas in saturated water vapor and blow the mixture into a liquid, thereby generating ultra fine bubbles. Still another example is an ultra fine pore method to deliver a gas into a liquid through ultra fine pores in ceramics and other materials, thereby generating ultra fine bubbles.

However, any of the production methods described above requires large apparatuses such as a high-pressure pump or an ultrasonic apparatus and a high degree of skill in an engineer to handle them, and also involves complicated cleaning after use. Furthermore, there are constraints on the physical properties and temperature conditions of the liquid used depending on the production method. In addition, the problem of contamination by impurities is inevitable.

### PRIOR ART DOCUMENTS

### Non-Patent Documents

[Non-patent Document 1] Ultrafine bubbles, the Journal of the Acoustical Society of Japan, Vol. 73, No. 7 (2017)

[Non-patent Document 2] What is fine bubble?, [online], the Union of Fine Bubble Scientists and Engineers, [searched on Sep. 5, 2019], Internet <http://www.fb-union.org/about.html>

[Non-patent Document 3] About ultra fine bubbles produced by ultra fine pore method, [online], ZERO WEB, Inc., [searched on Sep. 12, 2019], :Internet <http://ufb.zero-web.biz/#can>

### SUMMARY OF THE INVENTION

### Problems to be Solved by the Invention

An object of the present disclosure is to provide at least a technique for simply producing ultra fine bubbles.

### Means For Solving The Problems

An ultra fine bubble production apparatus comprising:
a container portion comprising a liquid and a gas; and
a drive portion for pressurization in the container portion, wherein
in the pressurization, a time required for pressure to reach maximum pressure from start of the pressurization is 2.0 milliseconds or less, and
the maximum pressure is 4.00 MPa or more.

The production apparatus according to [1], wherein a ratio of a volume of the gas to a volume of the container portion is 10% or more and 90% or less.

The production apparatus according to [1] or [2], wherein the liquid is water.

The production apparatus according to any one of [1] to [3], wherein the gas is air.

A method for producing an ultra fine bubble comprising:
preparing a system comprising a liquid and a gas; and
performing pressurization inside the system, wherein
in the pressurization, a time required for pressure to reach maximum pressure from start of the pressurization is 2.0 milliseconds or less, and
the maximum pressure is 4.00 MPa or more.

The method according to [5], wherein a ratio of a volume of the gas to a volume of the system is 10% or more and 90% or less.

The method according to [5] or [6], wherein the liquid is water.

The method according to any one of [5] to [7], wherein the gas is air.

### Effect Of The Invention

According to the present disclosure, at least a technique for simply producing ultra fine bubbles is provided.

According to the present disclosure, large apparatuses or a high degree of skill in the engineer to handle them are not required to produce ultra fine bubbles. In addition, in the present disclosure, there are no specific constraints on the liquid and temperature conditions as long as the liquid and temperature conditions usually used in the production of ultra fine hubbies are used. Furthermore, according to the present disclosure, ultra fine bubbles having a diameter equivalent to the diameter of a known product can be produced at a concentration equivalent to the concentration of the known product.

### BRIEF EXPLANATION OF THE DRAWINGS

FIG. 1 is a diagram illustrating a schematic configuration of an injection device according to an embodiment.

FIG. 2 is a diagram showing a relationship between the ratio of the volume of a gas to the volume of a container portion and the number of ultra fine bubbles generated in Example 2.

FIG. 3 is a diagram showing a relationship between the ratio of the volume of the gas to the volume of the container portion and the diameter and the number of ultra fine bubbles generated in Example 2.

FIG. 4 is a diagram showing a relationship between the diameter and the number of bubbles of air ultra fine bubble water (Nanox Co., Ltd.) used in a positive control in Example 2.

FIG. 5 is a diagram showing a relationship between the maximum pressure in pressurization in the container portion and the number of ultra fine bubbles generated in Example 3.

FIG. 6 is a diagram showing a relationship between the maximum pressure in the pressurization in the container portion and the diameter and the number of ultra fine bubbles generated in Example 3.

### MODE FOR CARRYING OUT THE INVENTION

An embodiment is an ultra fine bubble production apparatus comprising: a container portion comprising a liquid and a gas; and a drive portion for pressurization in the container portion, wherein in the pressurization, the time required for the pressure to reach the maximum pressure from the start of the pressurization is 2.0 milliseconds or less, and the maximum pressure is 4.00 MPa or more. Hereinafter, this production apparatus may be referred to as the “apparatus according to the present embodiment”.

“Ultra fine bubbles” herein mean bubbles with a diameter of less than 1 μm in accordance with discussions and definitions made by the Technical Committee TC281 (fine bubble technologies) of the International Organization for Standardization (ISO) as described above.

Note that, although most of the bubbles produced by the apparatus according to the present embodiment are ultra fine bubbles, it suffices if the bubbles produced by the apparatus according to the present embodiment include ultra fine bubbles and may include bubbles that do not satisfy the above-described definition.

In a method for measuring ultra fine bubbles used in examples described later, since the credibility of measurement results remains low when the number of bubbles is 2.5 billion bubbles/ml or less, it is assumed that ultra fine bubbles are generated when the number exceeds 2.5 billion bubbles/ml in the present disclosure.

Examples of the liquid used in the present embodiment include liquids (for example, water, alcohols, oils, and the like) that can be used as a solvent. Other examples include solutions (for example, culture solution (liquid culture medium), saline, phosphate buffer solution, prepared reagents, solution cosmetics, and the like). Other examples include emulsions (emulsion cosmetics, such as milky lotion, and the like). The liquid may be a liquid containing any two or more of these. Furthermore, the liquid may include low molecules or high molecules or may include an inorganic substance or an organic material (for example, a biological substance, such as a nucleic acid, and the like).

In a preferred aspect of the present embodiment, the liquid is a liquid that does not include microorganisms or the like.

In a preferred aspect of the present embodiment, the water is pure water (for example, distilled water, RC) water, RO-EDI water, ion exchanged water), ultrapure water, and in another preferred aspect, the water is ultrapure water. Examples of the ultrapure water include Milli-Q water.

Examples of the gas used in the present embodiment can include air. Other examples of the gas can include nitrogen, oxygen, ozone, carbon dioxide, hydrogen, and carbon monoxide, as well as a mixed gas of any two or more of these.

In a preferred aspect of the present embodiment, the gas is a gas that does not include microorganisms or the like.

The air may be commonly used air, the composition of which is not particularly limited. Examples of the air include a mixed gas containing about 80% of nitrogen and about 20% of oxygen.

In the present embodiment, in the pressurization in the container portion, the time required for the pressure to reach the maximum pressure from the start of the pressurization is 2.0 milliseconds or less.

In this context, the press means the pressure in the container portion. While the method for measuring the pressure is not particularly limited, for example, when an injection device described in the examples below is used for measurement, the method in the “Method for Measuring Pressure in Container Portion” section described later can be used for measurement.

The time required for the pressure to reach the maximum pressure from the start of the pressurization is usually 2.0 milliseconds or less, 1.0 milliseconds or less in a preferred aspect, and 0.60 milliseconds or less in another preferred aspect. When the time is 2.0 milliseconds or less, a part or the entirety of the gas in the system is instantaneously dissolved (mixed) in the liquid, and thus ultra fine bubbles are expected to be efficiently generated. Its lower limit is not particularly limited, but the time is usually greater than zero, for example, 0.20 milliseconds or more.

The maximum press is usually 4.00 MPa or more, 4.29 MPa or more in a preferred aspect, and 14.95 MPa or more in another preferred aspect. When the maximum pressure is 4.00 MPa or more, a part or the entirety of the gas in the system is instantaneously dissolved (mixed) in the liquid, and thus ultra fine bubbles are expected to be efficiently generated. It is effective to make the maximum pressure greater to increase the number of ultra fine bubbles. The upper limit of the maximum pressure depends on the pressurizing capacity of the production apparatus and is not particularly but the maximum pressure is usually 40 MPa or less.

In the present embodiment, the ratio of the volume of the gas to the volume of the container portion is not particularly limited, but is 10% or more in a preferred aspect and 90% or less in another preferred aspect.

In the present embodiment, the structure and the material of the container portion containing the liquid and the gas are not particularly limited as long as they can withstand the pressurization in the container portion.

The structure and the material of the drive portion are not particularly limited. The pressurization may, for example, be provided by the pressure generated when the pressure of compressed gas is released or by the pressure generated by the combustion of an explosive ignited by an ignition apparatus. Alternatively, the pressurization may be provided by the pressure utilizing electrical energy of a piezoelectric element or the like or mechanical energy of a spring or the like as the pressurization energy, and by the pressure utilizing the pressurization energy generated by appropriately combining these forms of energy.

When an aspect in which the pressure generated by the combustion of an explosive ignited by an ignition apparatus is employed as the pressurization, examples of the explosives include any one of an explosive containing zirconium and potassium perchlorate (ZPP), an explosive containing titanium hydride and potassium perchlorate (THPP), an explosive containing titanium and potassium perchlorate (TiPP), an explosive containing aluminum and potassium perchlorate (APP), an explosive containing aluminum and bismuth oxide (ABO), an explosive containing aluminum and molybdenum oxide (AMO), an explosive containing aluminum and copper oxide (ACO), an explosive containing aluminum and iron oxide (AFO), or an explosive composed of a combination of a plurality of these explosives. As characteristics of these explosives, the combustion product is gas at a high temperature but does not include a gas component at a room temperature, hence the combustion product is condensed immediately after the ignition. Accordingly, during the pressurization process of the liquid and the gas, temperature and the pressure of the combustion product under the pressurization generated by the combustion of an ignition charge can be shifted to the vicinity of the normal temperature and pressure in a short period of time after the pressure applied to the liquid and the gas reaches the first peak injection force.

Examples of the apparatus according to the present embodiment include an injection device. Details of the injection device will be described below.

In the injection device as an example of the apparatus according to the present embodiment, the container portion does not initially contain the liquid and the gas, but suctions the liquid and the gas through a nozzle having an injection port to contain them therein. By employing a configuration that requires a Milling operation into the container portion in this manner, a desired liquid and a desired gas can be contained. For this purpose, in the injection device, a syringe portion is detachably configured. An injection port at the distal end of the nozzle is sealed not to allow ejection of the liquid and the gas. The sealing member and the sealing method are not particularly limited as long as the liquid and the gas are prevented from being ejected.

With reference to the drawings, an injector 1 (needleless injector) is described below as an example of the injection device. Note that each of the configurations, combinations thereof, and the like in each embodiment is an example, and additions, omissions, substitutions, and other changes of the configuration may be made as appropriate without departing from the spirit of the present invention. The present invention is not limited by the embodiments and is limited only by the claims. This applies to the examples described later. Note that as terms indicating a relative positional relationship in a longitudinal direction of the injector 1, “distal end side” and “base end side” are used. “Distal end side” indicates a side close to the distal end of the injector 1 to be described later, that is, a position close to an injection port 31a, and “base end side” indicates a direction opposite to the “distal end side” in the longitudinal direction of the injector 1, that is, a direction toward a side of a drive portion 7. In addition, the present example is an example in which a container portion containing the liquid and the gas is pressurized using combustion energy of an explosive ignited by an ignition apparatus, but the present embodiment is not limited to this.

### Configuration of Injector 1

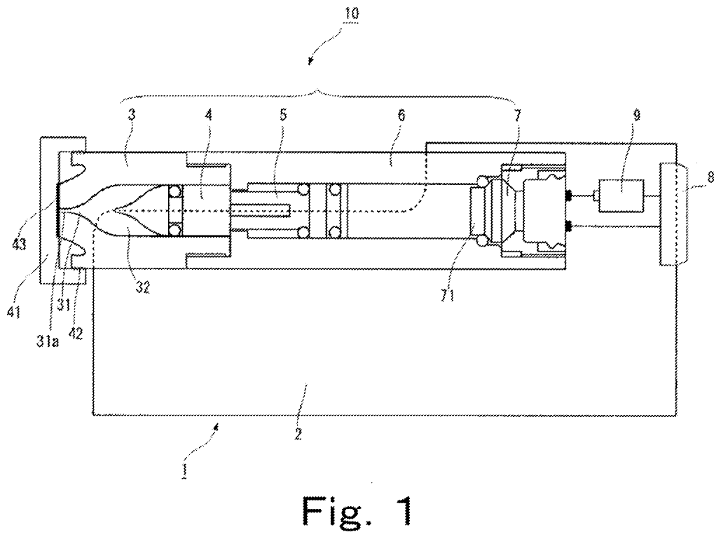

FIG. 1 is a cross-sectional view of the injector 1, taken along the longitudinal direction thereof, illustrating a schematic configuration of the injector 1. The injector 1 is formed by attaching an injector assembly 10 to a housing (injector housing) 2. The injector assembly 10 includes a subassembly including a syringe portion 3 and a plunger 4 and a subassembly including an injector body 6, a piston 5, and a drive portion 7, and the subassemblies are integrally assembled.

As described above, the injector assembly 10 is configured to be attachable and detachable to and from the housing 2. A container portion 32 formed between the syringe portion 3 and the plunger 4 included in the injector assembly 10 is filled with the liquid and the gas. The injector assembly 10 is a unit that is disposed each time ultra fine bubbles are generated. Therefore, unlike known ultra fine bubble production apparatuses, the part where ultra fine bubbles are generated needs not to be cleaned after the generation of the ultra fine bubbles. Furthermore, by producing ultra fine bubbles in a sterile environment, ultra fine bubbles in a sterile state can be easily produced. A battery 9 that supplies power to an igniter 71 included in the drive portion 7 of the injector assembly 10 is included on the housing 2 side. The power supply from the battery 9 is performed between an electrode on the housing 2 side and an electrode on the drive portion 7 side of the injector assembly 10 through wiring, when a user performs an operation of pressing a button 8 provided on the housing 2. The electrode on the housing 2 side and the electrode on the drive portion 7 side of the injector assembly 10 have shapes and positions designed to come into contact with each other automatically when the injector assembly 10 is attached to the housing 2. Further, the housing 2 is a unit that can be repeatedly used as long as power that can be applied to the drive portion 7 is left in the battery 9. When the battery 9 runs out of power in the housing 2, the housing 2 may continue to be used with only the battery 9 exchanged. The injection port 31a at the distal end of a nozzle 31 is sealed by a sealing portion 43 not to allow ejection of the liquid and the gas. The sealing portion 43 is fixed to a cap 41. The cap 41 is fixed to the syringe portion 3 via a fixing portion 42.

Next, the details of the injector assembly 10 will be described. First of all, a description is given on the subassembly including the syringe portion 3 and the plunger 4. In the syringe portion 3, the container portion 32 is formed as a space in which the gas can be contained. More specifically, as illustrated in FIG. 1, the plunger 4 is disposed to be slidable along an inner wall surface extending in the axial direction of the syringe portion 3, and the container portion 32 is defined by the inner wall surface of the syringe portion 3 and the plunger 4. The syringe portion 3 includes a nozzle portion 31 having the injection port 31a formed on the distal end side. In the example illustrated in FIG. 1, the plunger 4 has a contour on the distal end side shaped to substantially match the contour of the inner wall surface of the nozzle portion 31.

Furthermore, the syringe portion 3 includes the fixing portion 42 for fixing the cap 41. The cap 41 is fixed to the fixing portion 42. The cap 41 has the sealing portion 43 for sealing the injection port 31a. The injection port 31a of the nozzle portion 31 is sealed by the sealing portion 43 in a state where the cap 41 is fixed to the fixing portion 42 of the syringe portion 3. In this state, the container portion 32 in the syringe portion 3 is sealed in an airtight state. The cap 41 can be detachably fixed to the fixing portion 42 of the syringe portion 3. The nozzle portion 31 in the syringe portion 3 has a flow path that communicates with the injection port 31a and the container portion 32 as illustrated in FIG. 1, and the flow path has a flow path cross sectional area gradually decreasing from the container portion 32 side toward the injection port 31a side.

Next, the subassembly including the injector body 6, the piston 5, and the drive portion 7 will be described, For example, the piston 5 is made of metal and is configured to be pressurized by a combustion product (combustion gas) generated by the igniter 71 of the drive portion 7 and to slide in a through hole formed inside the injector body 6. The injector body 6 is a substantially cylindrical member, and the piston 5 is contained therein to be slidable along the inner wall surface extending in the axial direction thereof. The piston 5 may be formed of a resin, and in such a case, metal may be used together for a part to which heat resistance and pressure resistance are required. As illustrated in FIG. 1, the piston 5 is integrally coupled with the plunger 4.

Next, the drive portion 7 will be described. As illustrated in FIG. 1, the drive portion 7 is fixed to a base end side with respect to the through hole in the injector body 6. The drive portion 7 includes the igniter 71, which is an electric igniter. The igniter 71 is disposed to face the interior of the through hole in the injector body 6, and contains an ignition charge therein. As the ignition charge, various types of explosives can be employed as described above. In addition, the ignition charge can be contained in an explosive cup formed by an appropriate thin metal, for example.

Next, how the injector 1 having the configuration described above is operated will be described. As illustrated in FIG. 1, after the injector assembly 10 is mounted to the housing 2, with the cap 41 removed from the fixing portion 42 of the syringe portion 3, a desired liquid and gas are sucked through the injection port 31a of the nozzle portion 31. In this process, the order which the liquid and the gas are sucked and the number of times the suction is performed are not limited as long as the volume of the liquid and the volume of the gas sucked reach respective desired ratios with respect to the volume of the container portion in the end. For example, the liquid may be sucked first and the gas may be sucked thereafter to complete the containing, or vice versa. This allows the desired liquid and gas to be contained in the container portion 32. Next, the cap 41 is attached to the fixing portion 42 of the syringe portion 3. As a result, the injection port 31a of the nozzle portion 31 is sealed by the sealing portion 43, and thus the container portion 32 is air-tightly sealed.

In this state, when the user performs an operation of pressing the button 8 provided on the housing 2, for example, this serves as a trigger to supply the actuation power from the battery 9 to the igniter 71 of the drive portion 7, and thus the igniter 71 is activated. When the igniter 71 is activated, the ignition charge is ignited and thus combusted, and combustion products (flame, combustion gas, and the like) are generated. As a result, the explosive cup of the igniter 71 is ruptured, for example, and the combustion gas of the ignition charge is released into the through hole in the injector body 6. Thus, the pressure in the through hole of the injector body 6 suddenly increases, and the piston 5 is pressed toward the distal end side of the injector body 6. As a result, the piston 5 slides along the inner wall surface of the through hole in the injector body 6 toward the distal end side. As described above, because the plunger 4 is coupled integrally with the piston 5, the plunger 4 also slides along the inner surface of the syringe portion 3 in conjunction with the piston 5. That is, with the plunger 4 pushed toward the nozzle portion 31 located on the distal end side of the syringe portion 3, the volume of the container portion 32 containing the liquid and the gas decreases, and the liquid and the gas are suddenly pressurized.

As described above, when the igniter 71 in the drive portion 7 is activated, the plunger 4 is pushed through the piston 5 by the combustion energy of the ignition charge, and thus the liquid and the gas contained in the container portion 32 in an air-tightly sealed state are suddenly pressurized. Here, in the injector 1, the type and the dose of the ignition charge and any other parameters are adjusted so that the time required for the pressure in the container portion 32 to reach the maximum pressure from the start of the pressurization in the container portion 32 with the drive portion 7 (igniter 71) activated is 2.0 milliseconds or less and the maximum pressure is 4.00 MPa or more. As a result, ultra fine bubbles can be suitably generated. After ultra fine bubbles are generated in this way, for example, the injector assembly 10 is removed from the housing 2, and then the cap 41 is removed from the syringe portion 3. The contents including ultra fine bubbles contained in the container portion 32 may be gently pushed and emitted through the injection port 31a of the nozzle portion 31, for example, and collected in an appropriate container.

As described above, with the injector 1 as an example of the apparatus according to the present embodiment, ultra fine bubbles can be easily produced without requiring large apparatuses and a high degree of skill in the engineer to handle them. Furthermore, with the injector 1, the injector assembly 10 is detachably attached to the housing 2, and the injector assembly 10 can be configured as a disposable unit. Thus, it suffices if a used injector assembly 10 is disposed of after production of ultra fine bubbles. Thus, it is unnecessary to clean the used injector assembly 10 every time ultra fine bubbles are produced, which can reduce the time and labor of the user and provide an ultra fine bubble production apparatus with excellent usability.

Another embodiment is a method for producing ultra fine bubbles comprising: preparing a system comprising a liquid and a gas, and performing pressurization inside the system, wherein in the pressurization, a time required for the pressure to reach maximum pressure from start of the pressurization is 2.0 milliseconds or less, and the maximum pressure is 4.00 MPa or more.

The embodiment is a preferable aspect of the present embodiment.

That is, aspects of the preparing a system comprising a liquid and a gas are not limited as long as the system is prepared that can be pressurized in the performing pressurization inside the system, which is the next step. Examples of this system include the “container portion comprising a liquid and a gas” in the embodiment described above. Its specific aspects incorporate the description of the embodiment described above.

In addition, in the performing pressurization inside the system, aspects of the pressurization are not limited as long as the time required for the pressure to reach the maximum pressure from the start of the pressurization is 2.0 milliseconds or less, and the maximum pressure is 4.00 MPa or more. Examples of specific conditions include the conditions described in the embodiment described above. Examples of the mechanism for the pressurization include the pressurization by the “drive portion for pressurization in the container portion” described above. This drive portion may be included in the “system comprising a liquid and a gas” described above. Specific aspects of the drive portion incorporate the description of the embodiment described above.

### EXAMPLES

Examples are described below, but none of the examples are interpreted to be limiting.

[Example 1] Method for Measuring Pressure in Container Portion

In the following examples, the injection device described with reference to FIG. 1 was used as an apparatus for producing ultra fine bubbles, and ultra fine bubbles were produced in the container portion of the injection device. Known techniques were used to measure the time required for the pressure to reach the maximum pressure from the start of the pressurization and the maximum pressure. Namely, like the measurement method described in JP 2005-21640 A, measurement was performed by a method in which an injection force is applied in a dispersed manner to a diaphragm of a load cell disposed downstream of a nozzle and output from the load cell is collected by a data collection apparatus via a detection amplifier and is stored as an injection force (N) per unit time. The injection pressure measured in this manner was divided by the area of the injection port 31a of the injection device, and thus the injection pressure was calculated. Note that the volume of the container portion is 100 μl. The measurement value obtained by the internal pressure measurement of the container portion is equivalent to the injection pressure, and the injection pressure can be regarded as the pressure inside the container portion.

[Example 2] Effect of Volume Ratio of Liquid and Gas on Generation of Ultra Fine Bubbles

Samples were prepared on the day before the day to measure ultra fine bubbles. Through the nozzle of the injection device, 10 μl, 50 μl, or 90 μl of ultrapure water (Milli-Q water, Direct-Q (registered trademark) (Millipore Corporation)) was sucked, and then the plunger was pulled up to a 100-μl scale without further sucking any of the ultrapure water to fill normal air in the laboratory.

In the present example, the ZPP in the injection device was set to be 45 mg. In the nozzle side of the container portion, an ignition operation was performed in a state where the cap was securely mounted to make the inside of the container portion air-tightly sealed. After that, the container portion and the cap were removed from the injection device, and the content in the container portion was collected by gently pushing the content through the nozzle into a 1.5-ml tube. To 10 μl of a solution containing ultra fine bubbles generated immediately before measurement, 490 μl of Milli-Q water was added and gently mixed, and the number and the particle size of the ultra fine bubbles generated were measured and analyzed with NanoSight (Custom Design Japan).

Air ultra fine bubble water (Nanox Co., Ltd.) was used in a positive control. Note that the positive control was not intended to compare the number of ultra fine bubbles generated, but used to compare the diameter of ultra fine bubbles generated.

The results were as follows. Note that measurement was performed independently two to three times for each sample. The averages of the time required for the pressure to reach the maximum pressure from the start of the pressurization and the maximum pressure were taken.

In the method for measuring ultra fine bubbles used in the present example, since the credibility of measurement results remains low when the number of bubbles was 2.5 billion bubbles/ml or less, it was assumed that ultra fine bubbles were generated when the number exceeded 2.5 billion bubbles/ml.

When the ratio of the volume of the gas to the volume of the container portion was 10% (liquid volume 90 μl, gas volume 10 μl), the time required for the pressure to reach the maximum pressure from the start of the pressurization was 0.35 milliseconds and the maximum pressure was 15.18 MPa.

When the ratio of the volume of the gas to the volume of the container portion was 50% (liquid volume 50 μl, gas volume 50 μl), the time required for the pressure to reach the maximum pressure from the start of the pressurization was 0.25 milliseconds and the maximum pressure was 18.80 MPa.

When the ratio of the volume of the gas to the volume of the container portion was 90% (liquid volume 10 μl, gas volume 90 μl), the time required for the pressure to reach the maximum pressure from the start of the pressurization was 0.38 milliseconds and the maximum pressure was 17.33 MPa.

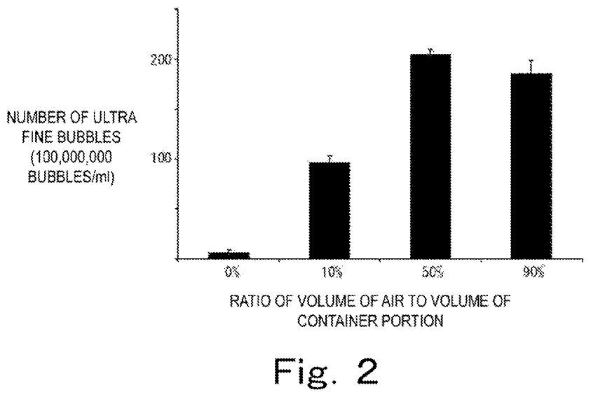

The numbers of ultra fine bubbles generated are shown in FIG. 2. It has been confirmed that a larger ratio of the volume of the gas to the volume of the container portion resulted in a larger number of ultra fine bubbles generated, and a plateau was reached when the ratio was around 50%.

Note that, according to FIG. 2, ultra fine bubbles seemed to be generated even when the ratio of the volume of the gas to the volume of the container portion was 0% (liquid volume 100 μl, gas volume 0); however, the number of the bubbles was 2.5 billion bubbles/ml or less, and thus no ultra fine bubbles were regarded to be generated as described above.

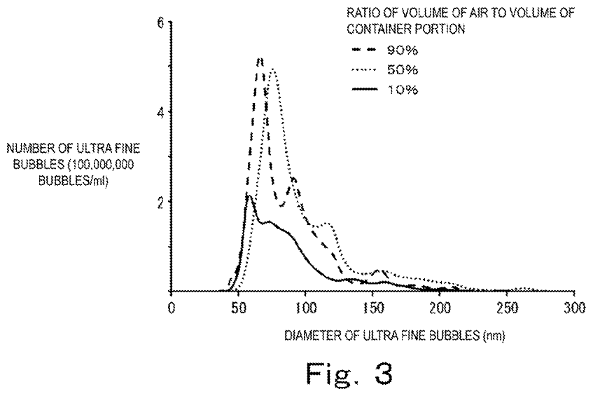

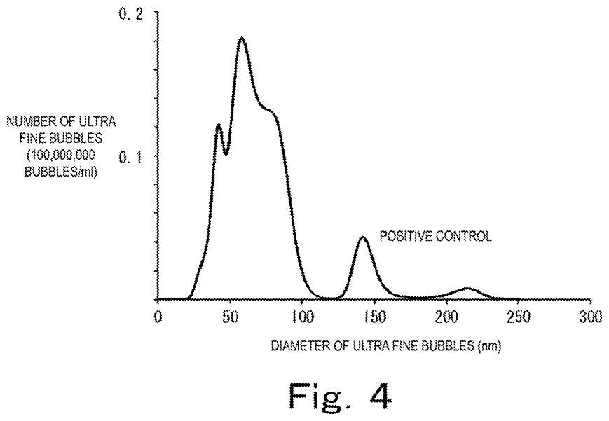

The diameters of ultra fine bubbles generated are plotted on FIG. 3. Furthermore, the diameters of bubbles of ultra fine bubble water (Nanox Co., Ltd.) used as the positive control are plotted on FIG. 4. The diameters of ultra fine bubbles generated have been found to have no significant difference from the diameters of the bubbles in the positive control.

[Example 3] Effect of Pressurization in Container Portion on Generation of Ultra Fine Bubbles

Based on the results of Example 2, the ratio of the volume of the gas to the volume of the container portion was fixed to 50% (liquid volume: 50 μl, gas volume 50 μl). In the present example, the ZPP amount in the injection device was set to be 25 mg, 35 mg, 45 mg, or 110 mg, and the other conditions were the same as in Example 2.

The results are listed in Table 1. Note that measurement was performed independently two to three times for each sample. The averages of the time required for the pressure to reach the maximum pressure from the start of the pressurization and the maximum pressure were taken.

When the ZPP amount was 25 mg, the time required for the pressure to reach the maximum pressure from the start of the pressurization was 0.35 milliseconds and the maximum pressure was 4.29 MPa.

When the ZPP amount was 35 mg, the time required for the pressure to reach the maximum pressure from the start of the pressurization was 0.25 milliseconds and the maximum pressure was 14.95 MPa.

When the ZPP amount was 45 mg, as in Example 2, the time required for the pressure to reach the maximum pressure from the start of the pressurization was 0.25 milliseconds and the maximum pressure was 18.80 MPa.

When the ZPP amount was 110 mg, the time required for the pressure to reach the maximum pressure from the start of the pressurization was 0.45 milliseconds and the maximum pressure was 39.35 MPa.

TABLE 1

| | Time required for pressure to reach | |
|---|---|---|
| | maximum pressure from start of | Maximum |
| ZPP amount | pressurization (ms) | pressure (MPa) |
| 25 mg | 0.35 | 4.29 |
| 35 mg | 0.25 | 14.95 |
| 45 mg | 0.25 | 18.80 |
| 110 mg | 0.45 | 39.35 |

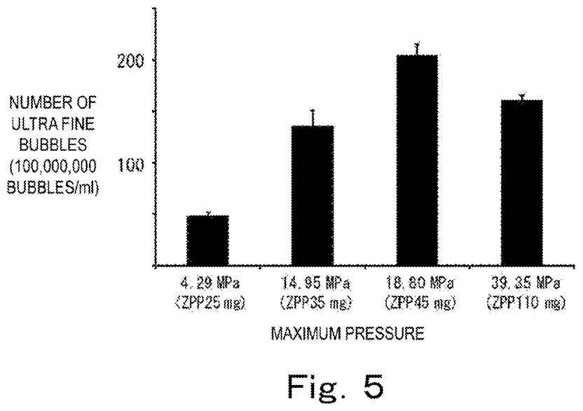

The numbers of ultra fine bubbles generated are indicated in FIG. 5. It has been confirmed that a larger maximum pressure resulted in a larger number of ultra fine bubbles generated, and a plateau was reached when the maximum pressure was around 18.80 MPa (ZIT amount: 45 mg).

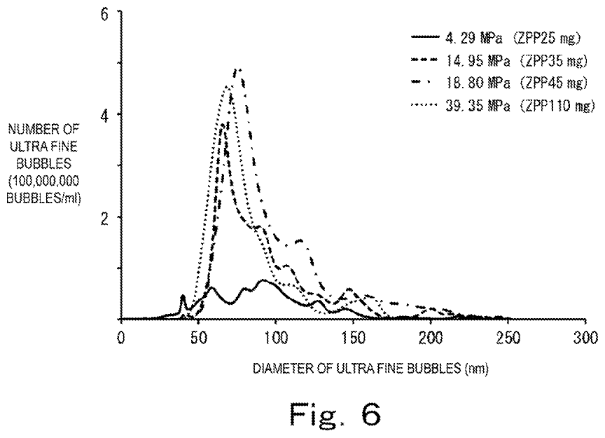

The diameters of ultra fine bubbles generated are plotted on FIG. 6. The diameters of ultra line hobbies generated under the conditions described above have been found to have no significant difference from the diameters of the bubbles in the positive control.

### EXPLANATION OF REFERENCES

1 Injector; 2 Housing; 3 Syringe portion; 4 Plunger; 5 Piston; 6 injector body; 7 Drive portion; 8 Button; 9 Battery; 10 Injector assembly; 31 Nozzle portion; 31a Injection port; 32 Container portion; 41 Cap; 42 Fixing portion; 43 Sealing portion; 71 Igniter

1. An ultra fine bubble production apparatus comprising:
a container portion comprising a liquid and a gas; and
a drive portion for pressurization in the container portion, wherein:
in the pressurization, a time required for pressure to reach maximum pressure from start of the pressurization is 2.0 milliseconds or less, and
the maximum pressure is 4.00 MPa or more.

2. The production apparatus according to claim 1, wherein a ratio of a volume of the gas to a volume of the container portion is 10% or more and 90% or less.

3. The production apparatus according to claim 1, wherein the liquid is water.

4. The production apparatus according to claim 1, wherein the gas is air.

5. A method for producing ultra fine bubbles comprising:
preparing a system comprising a liquid and a gas; and
performing pressurization inside the system, wherein:
in the pressurization, a time required for pressure to reach maximum pressure from start of the pressurization is 2.0 milliseconds or less, and
the maximum pressure is 4.00 MPa or more.

6. The method according to claim 5, wherein a ratio of a volume of the gas to a volume of the system is 10% or more and 90% or less.

7. The method according to claim 5, wherein the liquid is water.

8. The method according to claim 5, wherein the gas is air.
